(19) United States
(12) Patent Application Publication
(10) Pub. No.: US 2026/0311210 A1
(43) Pub. Date: Oct. 8, 2026

(54) SYSTEMS AND METHODS FOR INTEGRATING MEMBER IDENTIFIERS WITH POINT-OF-SALE SYSTEMS

(71) Applicant: JPMORGAN CHASE BANK, N.A., New York, NY (US)

(72) Inventors: Howard SPECTOR, Street, MD (US); Sridhar ARAVAMUDHAN, Middletown, DE (US); Louis CULOT, Brooklyn, NY (US); Edward J OLEBE, New Paltz, NY (US); Chris CONRAD, Philadelphia, PA (US); Emi ALEXANDER, New Canaan, CT (US)

(21) Appl. No.: 19/637,889

(22) Filed: Apr. 2, 2026

Related U.S. Application Data
(60) Provisional application No. 63/782,771, filed on Apr. 3, 2025.

(51) Int. Cl. G06Q 30/0238; G06Q 20/20

(52) U.S. Cl. CPC G06Q 30/0238; G06Q 20/204

(57) ABSTRACT

A method may include a computer program executed by an electronic device: creating a customer account for a customer; assigning a member identifier to the customer, wherein the member identifier uniquely identifies the customer; receiving payment card information for a payment instrument; generating a value from at least some of the payment card information; mapping the value to the member identifier; receiving, as part of a pending transaction, received payment card information for the payment instrument from a merchant point of sale device; generating a received value from at least some of the received payment card information; retrieving the member identifier from the mapping; applying a member benefit to the pending transaction; and executing the pending transaction.

### RELATED APPLICATIONS

This application claims priority to U.S. Provisional Patent Application Ser. No. 63/782,771, filed Apr. 3, 2025, the disclosure of which is hereby incorporated, by reference, in its entirety.

### BACKGROUND OF THE INVENTION

### 1. Field of the Invention

Embodiments relate to systems and methods for integrating member identifiers with point-of-sale systems.

### 2. Description of the Related Art

In a traditional network, when a merchant runs a transaction its path is fixed, ending up at the issuer’s system. In some cases, the payment network may stand in when the issuer’s system is down or slow.

### SUMMARY OF THE INVENTION

Systems and methods for integrating member identifiers with point-of-sale systems are disclosed. According to an embodiment, a method may include: creating, by a computer program executed by an electronic device, a customer account for a customer; assigning, by the computer program, a member identifier to the customer, wherein the member identifier uniquely identifies the customer; receiving, by the computer program, payment card information for a payment instrument; generating, by the computer program, a value from at least some of the payment card information; mapping, by the computer program, the value to the member identifier; receiving, by the computer program and as part of a pending transaction, received payment card information for the payment instrument from a merchant point of sale device; generating, by the computer program, a received value from at least some of the received payment card information; retrieving, by the computer program, the member identifier from the mapping; applying, by the computer program, a member benefit to the pending transaction; and executing, by the computer program, the pending transaction.

In an embodiment, the payment card information comprises a primary account number, an expiration date, and/or a CVV/CVV2 value.

In an embodiment, the value and the received value comprise a hash of at least some of the payment information.

In an embodiment, the member benefit comprises a discount.

In an embodiment, the method may also include: sending, by the computer program, the member identifier to an issuer of the payment instrument; receiving, by the computer program, an issuer benefit from the issuer; and applying, by the computer program, the issuer benefit to the pending transaction.

In an embodiment, the issuer is configured to link the payment instrument to the member identifier.

According to another embodiment, a system may include: a merchant backend; and a merchant point of sale device in communication with the merchant backend. The merchant backend is configured to create a customer account for a customer; the merchant backend is configured to assign a member identifier to the customer, wherein the member identifier uniquely identifies the customer; the merchant point of sale device is configured to receive payment card information from a payment instrument and to provide the payment card information to the merchant backend; the merchant backend is configured to generate a value from at least some of the payment card information; the merchant backend is configured to map the value to the member identifier; the merchant point of sale device is configured to receive as part of a pending transaction received payment card information from the payment instrument and to provide the received payment card information to the merchant backend; the merchant backend is configured to generate a received value from at least some of the received payment card information; the merchant backend is configured to retrieve the member identifier from the mapping; the merchant backend is configured to apply a member benefit to the pending transaction; and the merchant backend is configured to execute the pending transaction.

In an embodiment, the payment card information comprises a primary account number, an expiration date, and/or a CVV/CVV2 value.

In an embodiment, the value and the received value comprise a hash of at least some of the payment information.

In an embodiment, the member benefit comprises a discount.

In an embodiment, the system may also include an issuer backend that is configured to send the member identifier and/or the received payment card information to an issuer of the payment instrument and to identify an issuer benefit for the transaction. The merchant is further configured to receive an issuer benefit from the issuer and to apply the issuer benefit to the pending transaction.

In an embodiment, the issuer is further configured to link the payment instrument to the member identifier.

According to another embodiment, a non-transitory computer readable storage medium may include instructions stored thereon, which when read and executed by one or more computer processors, cause the one or more computer processors to perform steps comprising: creating a customer account for a customer; assigning a member identifier to the customer, wherein the member identifier uniquely identifies the customer; receiving payment card information for a payment instrument; generating a value from at least some of the payment card information; mapping the value to the member identifier; receiving, as part of a pending transaction, received payment card information for the payment instrument from a merchant point of sale device; generating a received value from at least some of the received payment card information; retrieving the member identifier from the mapping; applying a member benefit to the pending transaction; and executing the pending transaction.

In an embodiment, the payment card information comprises a primary account number, an expiration date, and/or a CVV/CVV2 value.

In an embodiment, the value and the received value comprise a hash of at least some of the payment information.

In an embodiment, the member benefit comprises a discount.

In an embodiment, the non-transitory computer readable storage medium may also include instructions stored thereon, which when read and executed by the one or more computer processors, cause the one or more computer processors to perform steps comprising: sending the member identifier to an issuer of the payment instrument; receiving an issuer benefit from the issuer; and applying the issuer benefit to the pending transaction.

In an embodiment, the issuer is configured to link the payment instrument to the member identifier.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for integrating member identifiers with point-of-sale systems according to an embodiment;

FIG. 2 illustrates a method for linking a member identifier to a payment card according to an embodiment;

FIG. 3 illustrates a method for conducting a transaction using member identifiers with point-of-sale systems according to an embodiment;

FIG. 4 illustrates a method for using member identifiers with point-of-sale systems according to another embodiment;

FIG. 5 illustrates a method for using member identifiers with point-of-sale systems according to another embodiment;

FIG. 6 illustrates a method for using member identifiers with point-of-sale systems according to another embodiment;

FIG. 7 illustrates a method for dynamic re-routing of a transaction according to an embodiment according to an embodiment;

FIG. 8 illustrates a method for customer information sharing according to an embodiment;

FIG. 9 depicts an exemplary computing system for implementing aspects of the present disclosure.

### DETAILED DESCRIPTION OF PREFERRED EMBODIMENTS

Systems and methods for integrating member identifiers with point-of-sale systems are disclosed.

In embodiments, a customer may link a member identifier with a merchant, and the link may be used to identify any payment cards that the customer may have registered with the merchant.

An example of a member identifier is a customer identifier.

In an embodiment, a merchant may know the customer’s member identifier. The customer may provide the member identifier directly, or indirectly (e.g., by providing a registered phone number, email address, biometric identifier, etc.) to the merchant. When the customer checks out online or in person by presenting a payment card, the merchant will be able to tell if the card being used is linked to another payment card for the customer. If the payment card is not linked, the merchant may perform any required validations and then send the customer’s member identifier over the network (purchase transaction or other) to instruct the network or issuer to link the payment card to the customer’s member identifier.

In another embodiment, the merchant may not know the customer’s member identifier. For example, the customer may check out at the merchant with a card that is not linked to the customer’s member identifier, and the customer has not provided, directly or indirectly, the customer’s member identifier to the merchant. The network or issuer may identify that the customer has another card that is linked to the member identifier and may provide the merchant an indicator of such in the authorization response. For example, the authorization response may indicate that the merchant and the customer already have a relationship and may provide the customer’s member identifier to the merchant. The merchant may then then link the payment card to the membership identifier and the customer may be eligible for any benefits.

In another embodiment, the customer’s member identifier may be on file with the merchant and may have a payment method associated with it (e.g., credit card, debit card, etc.). Instead of using a payment card, the merchant may conduct a transaction with the customer’s member identifier. The customer’s member identifier may be routed to the issuer for the associated payment method and the issuer may perform the transaction authorization using a secure mapping between the member identifier and the payment method. This removes Payment Card Industry concerns as the customer’s payment information would not be stored. In embodiments, the customer’s member identifier could only be used with the merchant associated with the member identifier, and not with other merchants.

In another embodiment, the merchant may not know the customer’s member identifier, but may offer the customer (in person, web pop up box, chat box, etc.) a new payment card in order to receive additional member benefits. If the customer agrees, there is no need to re-run the transaction, and the merchant may instruct the network to realign the purchase to the customer’s new payment device (e.g., a co-brand card) without customer interaction. The network may unwind the first transaction and then reapply the transaction to the new payment card. This may involve, for example, dynamic re-routing of the transaction.

In embodiments, a transaction that is being conducted may be re-routed to another issuer, or to another method of payment. This may be done at the request of the customer, based on a merchant configuration, etc.

In embodiments, the issuers and the network may agree on a common standard for linking know your customer (KYC) information to allow for cross-issuer functionality. One example may involve matching the customer social security number or tax identification number to an account. Machine learning, however, may be used to identify matches and miss-matches based on training populations from each participant.

Customers may opt-in to dynamic routing in order to receive the best deal or best offer, or to use a different payment card when the presented payment card is near its credit limit. The customer may also set rules at their issuer or directly on the network for when to route which types of transactions in which direction. Before re-routing a transaction, the customer may be asked for approval by sending in-app message, text message, etc. to the customer’s electronic device.

The network may charge a fee for dynamic re-routing due to the benefits to the merchants and customers. The network may manage the money movement and other operational issues, such as disputes. The merchant and/or issuers may be unaware of the inner workings.

Embodiments may further support routing and/or splitting transactions across issuers and others. Embodiments may dynamically retrieve gift card balances that could be applied to the purchase and may handle any conversion rate between the gift cards so that the gift card may be used with the current transaction.

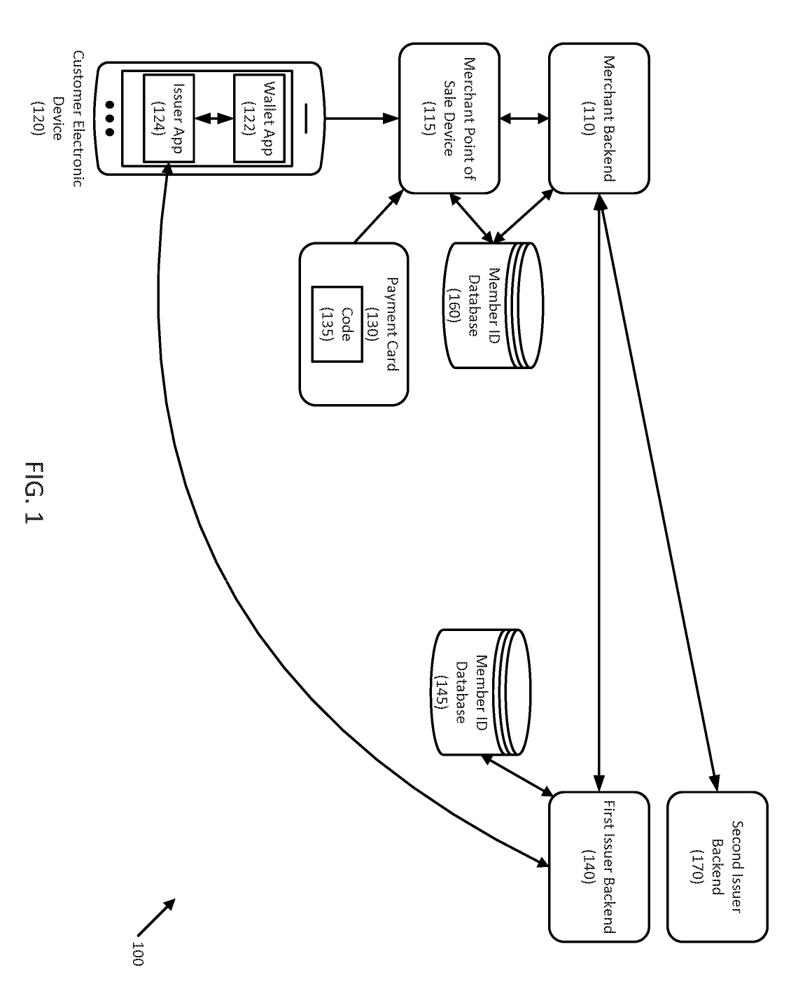

FIG. 1 depicts a system for integrating member identifiers with point-of-sale systems according to an embodiment. System 100 may include a merchant including merchant backend 110 and merchant point of sale device 115. Merchant point of sale device 115 may interact with customer electronic device 120, which may be a computer, a smart device (e.g., a smart watch, a smart phone, etc.), an Internet of Things (IoT) appliance, etc. Customer electronic device 120 may execute one or more computer programs or applications, including wallet application 122, issuer application 124, etc.

Wallet application 122 may store payment card information, such as tokens, identifiers, etc. for payment cards that have been provisioned to wallet application 122. Wallet application 122 may further interact with issuer application 124. Issuer application 124 may interface with issuer backend 140.

Merchant backend 110 and issuer backend 140 may settle a transaction using, for example, a transaction identifier, authorization number, or any other suitable identifier for the transaction.

Merchant point of sale device 115 and/or merchant backend may store member identifiers for customers in member ID database 160. Member ID database 160 may maintain a mapping of member identifiers to payment cards.

In another embodiment, issuer backend 140 may maintain a mapping of member identifiers to payment cards, so that when merchant backend 110 submits an authorization request with a member identifier to issuer backend 140, it can retrieve a payment card that is mapped to the member identifier.

First issuer backend 140 may maintain its own member ID database 145.

System 100 may further include payment card 130, which may be a physical payment device (e.g., a credit card, a debit card, etc.) Payment card 130 may include code 135, which may be an optical code (e.g., a QR code, a bar code, etc.). Code 135 may indicate to point of sale device 115 that a transaction will be conducted without using a payment network, such as by using a wallet provider backend or a similar payment provider.

System 100 may further include second issuer backend 170. In embodiments, a transaction may be dynamically re-routed between second issuer backend 170 and first issuer backend 140. Merchant backend 110, or a network (not shown) may perform the dynamic re-routing.

In embodiments, a gift card may be used for a transaction. For example, merchant backend 110 may request a gift card balance from the issuer of the gift card via the network after the dynamic routing of the transaction, and may then split the transaction as necessary and/or desired.

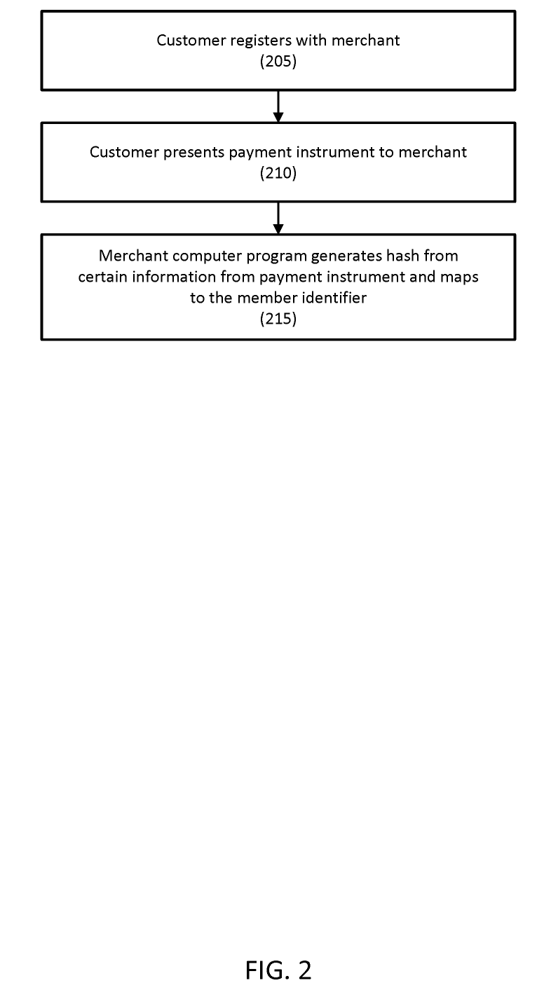

FIG. 2 illustrates a method for linking a member identifier to a payment card according to an embodiment.

In step 205, a customer may register and create an account with a merchant. In an embodiment, the customer may provide customer information, such as the customer’s name, address, email address, phone number, etc.

In an embodiment, the customer may register in person, online, etc.

After registration, a merchant computer program may assign the customer and/or the customer account a member identifier that may uniquely identify the customer. The member identifier may be an alphanumeric string, the customer’s email address or phone number, etc.

In an embodiment, the customer’s email address or phone number may be an alias for a member identifier maintained by the merchant.

In step 210, the customer may register a payment instrument, such as a credit card, with the merchant. In an embodiment, the customer may provide payment card information, such as a card number (e.g., a primary account number), an expiration date, CVV/CVV2 data, other track data, etc. In another embodiment, the customer may tap or present the card to a merchant point of sale device, where the information may be read.

In step 215, the merchant computer program may use some of the information from the financial instrument to generate a value, and may map that value to the member identifier. For example, the merchant computer program may hash one or more values from the financial instrument, and may map the hash to the member identifier. The merchant may then store the mapping.

In another embodiment, the hash may be used as the member identifier, so no mapping is required.

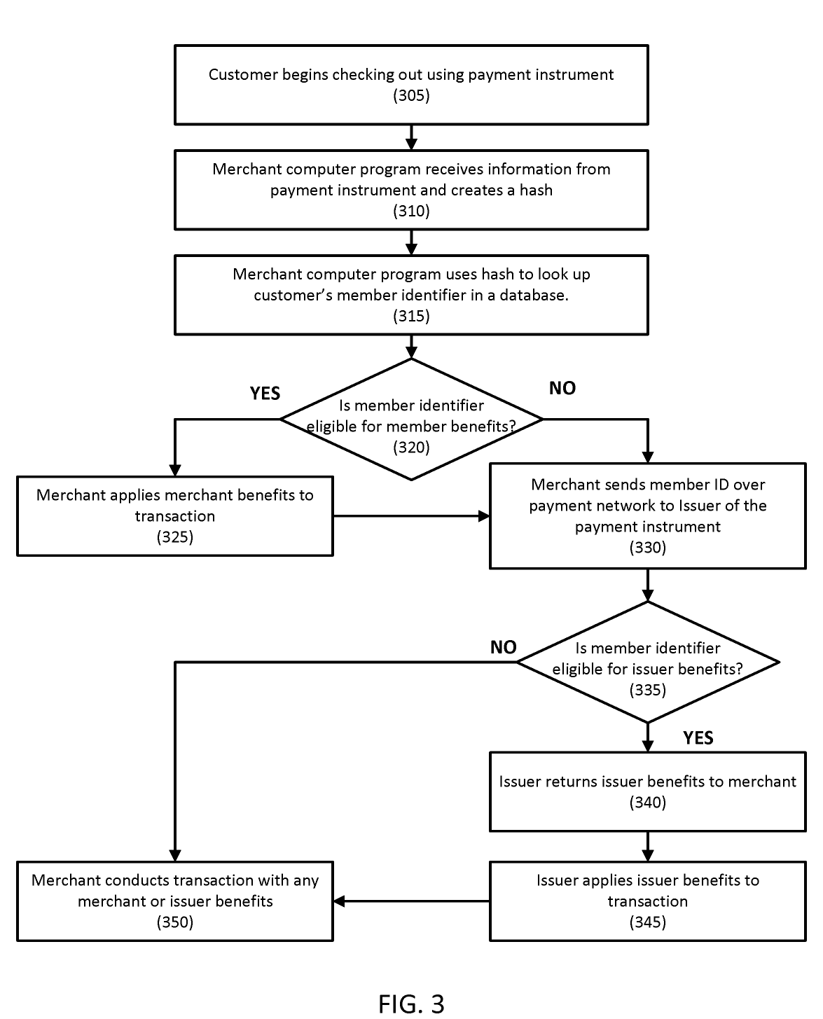

FIG. 3 illustrates a method for conducting a transaction using member identifiers with point-of-sale systems according to another embodiment.

In step 305, a customer that has registered with a merchant may being a checkout process for a pending transaction at a merchant point of sale device and may present the payment instrument to the point of sale device. The merchant point of sale device may read information from the payment instrument.

In step 310, the merchant computer program may use information from the payment instrument to create a hash. The merchant computer program may use the same information that was used to create the hash during registration to create this hash.

In step 315, the merchant computer program may use the hash to retrieve the member identifier for the customer form the mapping.

In step 320, the merchant computer program may determine whether the member identifier is eligible for any member benefits, such as discounts, from the merchant, or if any member benefits are available. The member benefits may be based on the good/service being purchased, the price, the location, etc.

If member benefits are available, in step 325, the merchant computer program may apply the merchant benefits to the pending transaction.

After the merchant benefits are applied, or if the member identifier is not eligible for member benefits or there are no member benefits available, in step 330, the merchant computer program may send the member identifier and/or payment card information over the payment network or a separate network to the issuer of the payment instrument, or to the payment network.

In step 335, the issuer may determine whether there are any issuer benefits available to the member identifier, such as benefits based on the issuer’s relationship with the merchant. The issuer benefits may be based on the good/service being purchased, the price, the location, etc.

If there are, in step 340, the issuer may return the issuer benefits to the merchant computer program.

In step 345, the merchant may receive the issuer benefits and may apply them to the pending transaction. Thus, instead of issuer benefits being applied post-transaction, the issuer benefits are applied at the time of transaction, and are presented to the customer.

The pending transaction may then be executed.

In step 350, the transaction may be conducted with any benefits, including merchant and/or issuer benefits.

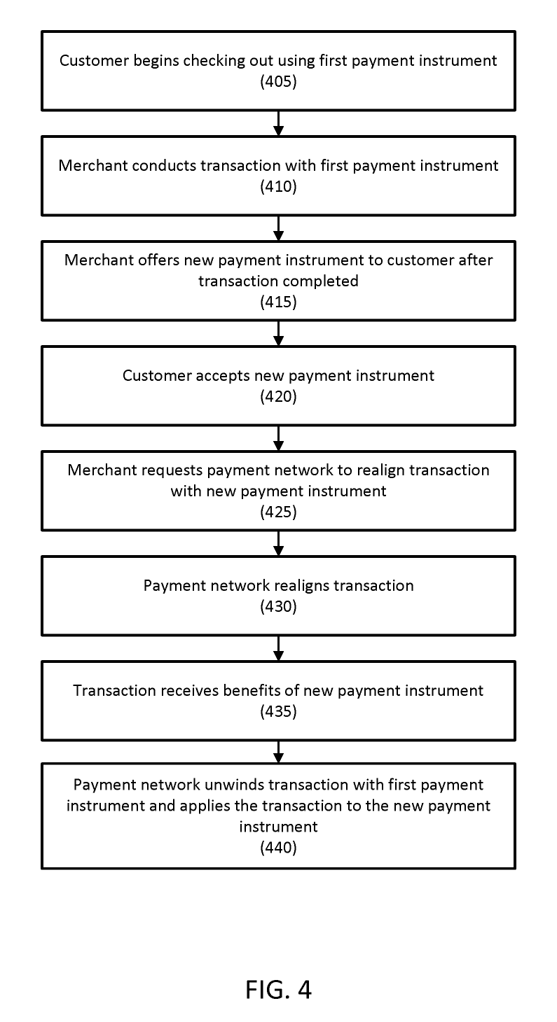

FIG. 4 illustrates a method for using member identifiers with point-of-sale systems according to another embodiment.

In step 405, a customer may begin checking out using a first payment instrument.

In step 410, the merchant may conduct a transaction with the first payment instrument.

In step 415, after the transaction is completed, the merchant may offer a new payment instrument to the customer. The new payment instrument may provide certain member benefits or issuer benefits to the customer.

In step 420, the customer may accept the new payment instrument.

In step 425, the merchant computer program may request the payment network to realign the transaction with the new payment instrument.

In step 430, the payment network may realign the transaction with the new payment instrument. In an embodiment, the payment network may replace the first payment instrument with the new payment instrument and may provide the transaction to the issuer. In another embodiment, the payment network may cancel the transaction with the first payment instrument and may conduct a new transaction with the new payment instrument.

In step 435, after realignment, the transaction may receive the benefits of the new payment instrument.

In step 440, the payment network may unwind the transaction with the first payment instrument, and may apply the transaction to the new payment instrument.

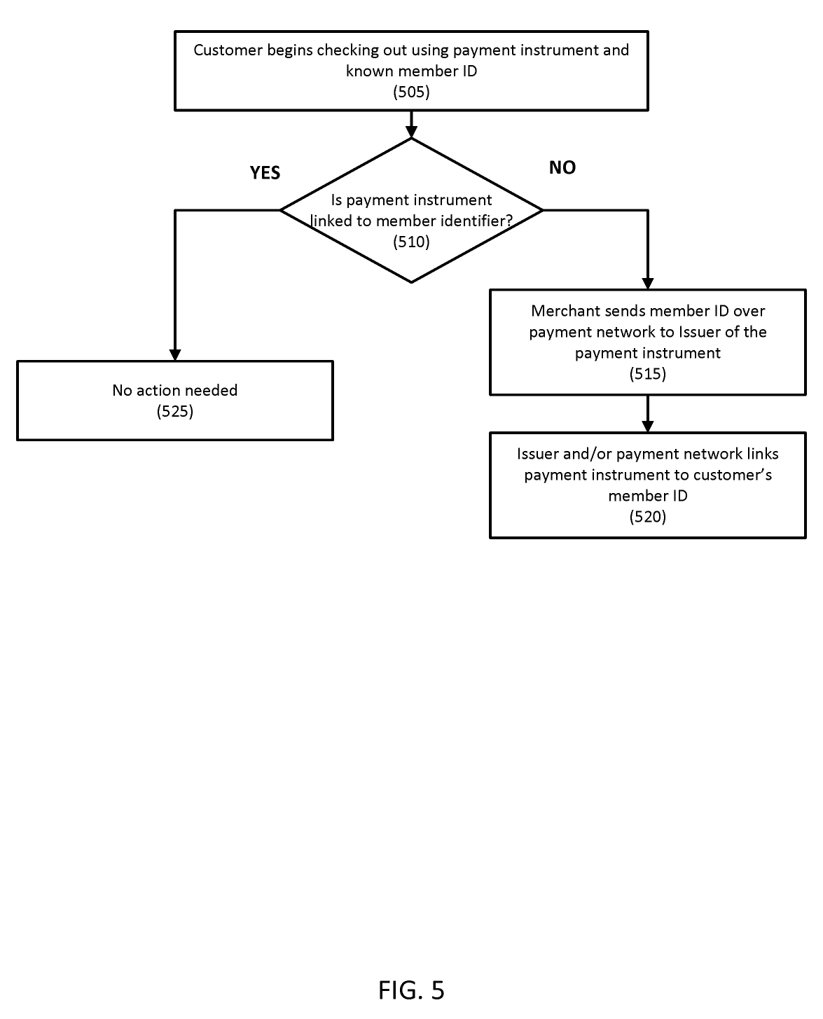

FIG. 5 depicts a method for using member identifiers with point-of-sale systems according to another embodiment.

In step 505, a customer may check out using a payment instrument and a known member ID. In an embodiment, if the member identifier is not known, the merchant computer program may retrieve it using information from the payment instrument, visual information available on the payment instrument, etc. as described in FIG. 3.

In step 510, the merchant computer program may determine whether the payment instrument is linked to the member identifier so that the payment instrument receives member benefits.

If the payment instrument is not linked, in step 515, the merchant computer program may send the member identifier over the payment network to the issuer of the payment instrument, or to the payment network.

In step 520, the issuer and/or the payment network may link the payment instrument to the customer’s member identifier.

In step 525, no action is needed.

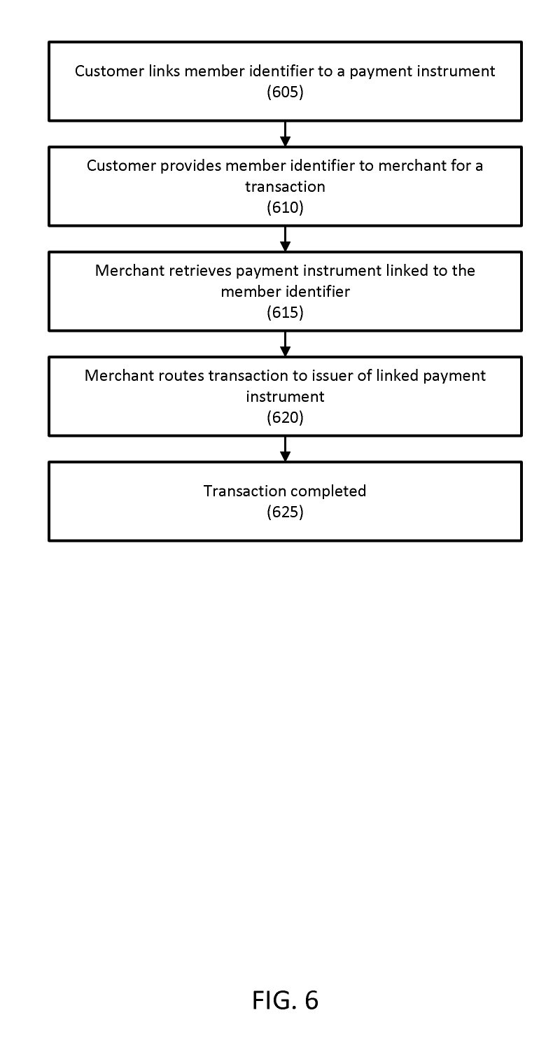

FIG. 6 depicts a method for using member identifiers with point-of-sale systems according to another embodiment.

In step 605, a customer may link a member identifier to a payment instrument. In an embodiment, the customer may do this on a merchant application, a merchant website, etc.

In step 610, the customer may provide the customer’s member identifier to a merchant point of sale device as part of a checkout process for a transaction. The customer does not provide the merchant with the payment instrument.

For example, the customer may provide the merchant with the customer’s member identifier by having a merchant point of sale device scan a machine readable code, by entering a phone number that may be linked to the member identifier, by entering the member identifier directly, etc.

In step 615, the merchant computer program may retrieve the payment instrument that is linked to the member identifier.

In step 620, the merchant computer program may route the transaction to the issuer of the linked payment instrument for processing.

In step 625, the transaction may be completed.

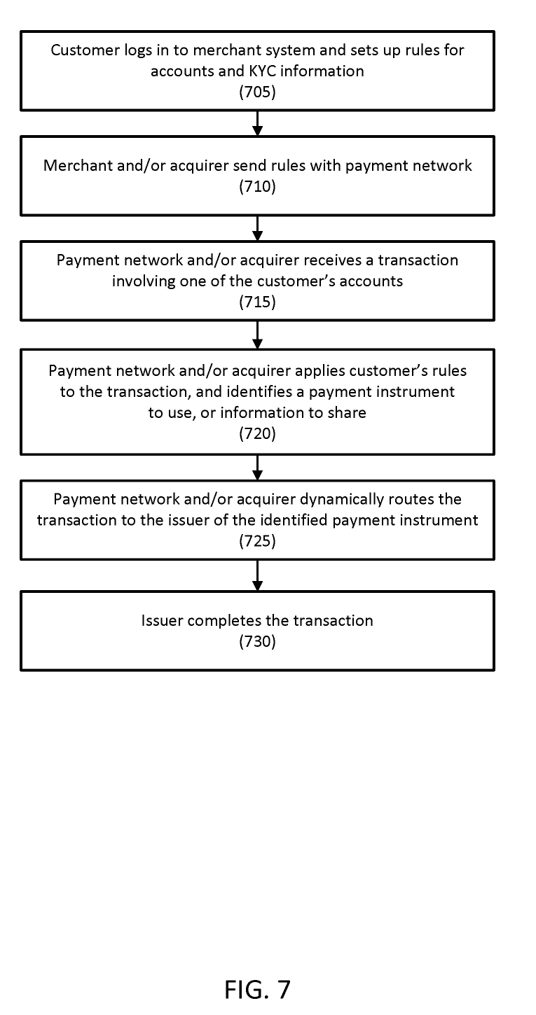

FIG. 7 depicts a method for dynamic re-routing of a transaction according to an embodiment. In embodiments, a customer may opt-in to dynamic routing and may set up sharing rules. Merchant systems or the acquirer may support network messages that enable funding and dispute resolution for cross-account interactions. The network may dynamically build a customer’s list of accounts from shared information (e.g., KYC information) or through aggregators, and may dynamically route transactions between issuers. The issuers may share KYC data and account information and may support the network messages for funding and dispute resolution.

Issuers may enable customers to link payment instruments and to define rules as to when to call one versus another (open banking or similar could be used to get the data). Issuers may send required information and keys to the network/acquirer for each selection allowing the network/acquirer to use the payment instrument based on the rules provided by the issuer.

In step 705, a customer may log in to a merchant system and may set up rules for accounts and other information (e.g., KYC information). For example, the customer may identify merchants and entities with which customer information may be shared, the type of customer information that may be shared and not shared, etc.

In step 710, the merchant and/or the acquirer may send the customer’s rules with a payment network. In an embodiment, the customer’s rules may be associated with the customer’s member identifier.

In step 715, the payment network and/or acquirer may receive a transaction involving one of the customer’s accounts.

In step 720, the payment network and/or acquirer may apply the customer’s rules to the transaction, and may identify a payment instrument to use, or information to share.

In step 725, the payment network and/or acquirer may dynamically route the transaction to the issuer of the identified payment instrument.

In step 730, the issuer may complete the transaction. In one embodiment, the member identifier may be used to identify the correct account to be charged for the purchase.

Embodiments may enable the following: (1) route the transaction to a backup payment card when the one presented has an issue or is declined; (2) route the transaction to other payment types based on customer preferences or a merchant configuration for a given type of transaction; (3) split a transaction across multiple payment types (including non-traditional methods) and/or issuers and manage the process so the issuers and the merchants are abstracted from the details; (4) resolution of disputes on a split transactions by using rules regarding which leg of the transaction must be resolved first and the rest would follow (although the resolution between the split portion of the transactions may be different inside the network, the customer will be made whole based on the decision); and the sharing of data by issuers on the network, or the use of aggregators.

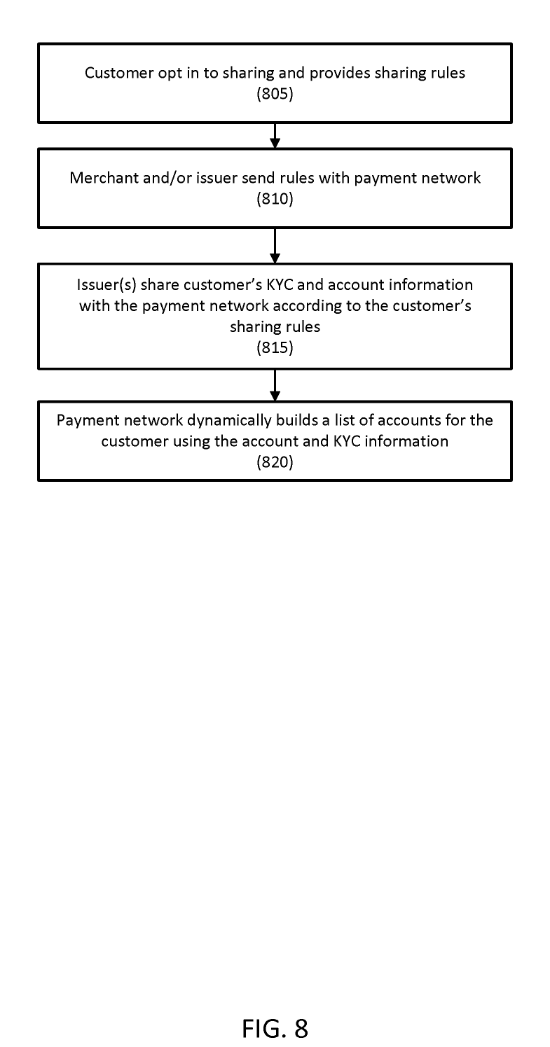

Referring to FIG. 8, a method for customer information sharing is provided according to an embodiment. In step 805, a customer may opt in to sharing and may provide its sharing rules. In an embodiment the customer may provide the sharing rules to a merchant system, to an issuer, etc. For example, the customer may identify merchants and entities with which customer information may be shared, the type of customer information that may be shared and not shared, etc.

In step 810, the merchant system or the issuer may provide the sharing rules to a payment network. In one embodiment, a new value-added service that is supported by the merchant, the acquirer, the payment network, and the issuer may be implemented to support the sharing.

In step 815, the issuer(s) may share the customer’s KYC and account information with the payment network according to the customer’s sharing rules.

In step 820, the payment network may dynamically build a list of accounts for the customer using the account and KYC information. In an embodiment, the payment network may also receive account information from an aggregator.

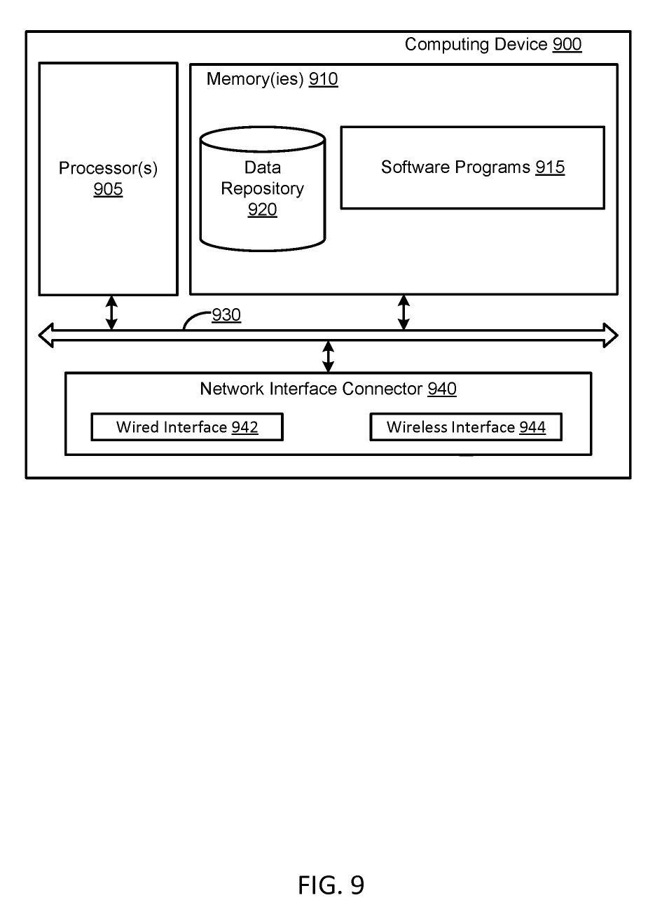

FIG. 9 depicts an exemplary computing system for implementing aspects of the present disclosure. FIG. 9 depicts exemplary computing device 900. Computing device 900 may represent the system components described herein. Computing device 900 may include processor 905 that may be coupled to memory 910. Memory 910 may include volatile memory. Processor 905 may execute computer-executable program code stored in memory 910, such as software programs 915. Software programs 915 may include one or more of the logical steps disclosed herein as a programmatic instruction, which may be executed by processor 905. Memory 910 may also include data repository 920, which may be nonvolatile memory for data persistence. Processor 905 and memory 910 may be coupled by bus 930. Bus 930 may also be coupled to one or more network interface connectors 940, such as wired network interface 942 or wireless network interface 944. Computing device 900 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other and features from an embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In an embodiment, the processing machine may be a specialized processor.

In an embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
creating, by a computer program executed by an electronic device, a customer account for a customer;
assigning, by the computer program, a member identifier to the customer, wherein the member identifier uniquely identifies the customer;
receiving, by the computer program, payment card information for a payment instrument;
generating, by the computer program, a value from at least some of the payment card information;
mapping, by the computer program, the value to the member identifier;
receiving, by the computer program and as part of a pending transaction, received payment card information for the payment instrument from a merchant point of sale device;
generating, by the computer program, a received value from at least some of the received payment card information;
retrieving, by the computer program, the member identifier from the mapping;
applying, by the computer program, a member benefit to the pending transaction; and
executing, by the computer program, the pending transaction.

2. The method of claim 1, wherein the payment card information comprises a primary account number, an expiration date, and/or a CVV/CVV2 value.

3. The method of claim 1, wherein the value and the received value comprise a hash of at least some of the payment information.

4. The method of claim 1, wherein the member benefit comprises a discount.

5. The method of claim 1, further comprising:
sending, by the computer program, the member identifier to an issuer of the payment instrument;
receiving, by the computer program, an issuer benefit from the issuer; and
applying, by the computer program, the issuer benefit to the pending transaction.

6. The method of claim 5, wherein the issuer is configured to link the payment instrument to the member identifier.

7. A system, comprising:
a merchant backend; and
a merchant point of sale device in communication with the merchant backend;
wherein:
the merchant backend is configured to create a customer account for a customer;
the merchant backend is configured to assign a member identifier to the customer, wherein the member identifier uniquely identifies the customer;
the merchant point of sale device is configured to receive payment card information from a payment instrument and to provide the payment card information to the merchant backend;
the merchant backend is configured to generate a value from at least some of the payment card information;
the merchant backend is configured to map the value to the member identifier;
the merchant point of sale device is configured to receive as part of a pending transaction received payment card information from the payment instrument and to provide the received payment card information to the merchant backend;
the merchant backend is configured to generate a received value from at least some of the received payment card information;
the merchant backend is configured to retrieve the member identifier from the mapping;
the merchant backend is configured to apply a member benefit to the pending transaction; and
the merchant backend is configured to execute the pending transaction.

8. The system of claim 7, wherein the payment card information comprises a primary account number, an expiration date, and/or a CVV/CVV2 value.

9. The system of claim 7, wherein the value and the received value comprise a hash of at least some of the payment information.

10. The system of claim 7, wherein the member benefit comprises a discount.

11. The system of claim 7, further comprising:
an issuer backend that is configured to send the member identifier and/or the received payment card information to an issuer of the payment instrument and to identify an issuer benefit for the transaction; and
the merchant is further configured to receive an issuer benefit from the issuer and to apply the issuer benefit to the pending transaction.

12. The system of claim 11, wherein the issuer is further configured to link the payment instrument to the member identifier.

13. A non-transitory computer readable storage medium, including instructions stored thereon, which when read and executed by one or more computer processors, cause the one or more computer processors to perform steps comprising:
creating a customer account for a customer;
assigning a member identifier to the customer, wherein the member identifier uniquely identifies the customer;
receiving payment card information for a payment instrument;
generating a value from at least some of the payment card information;
mapping the value to the member identifier;
receiving, as part of a pending transaction, received payment card information for the payment instrument from a merchant point of sale device;
generating a received value from at least some of the received payment card information;
retrieving the member identifier from the mapping;
applying a member benefit to the pending transaction; and
executing the pending transaction.

14. The non-transitory computer readable storage medium of claim 13, wherein the payment card information comprises a primary account number, an expiration date, and/or a CVV/CVV2 value.

15. The non-transitory computer readable storage medium of claim 13, wherein the value and the received value comprise a hash of at least some of the payment information.

16. The non-transitory computer readable storage medium of claim 13, wherein the member benefit comprises a discount.

17. The non-transitory computer readable storage medium of claim 13, further including instructions stored thereon, which when read and executed by the one or more computer processors, cause the one or more computer processors to perform steps comprising:
sending the member identifier to an issuer of the payment instrument;
receiving an issuer benefit from the issuer; and
applying the issuer benefit to the pending transaction.

18. The non-transitory computer readable storage medium of claim 17, wherein the issuer is configured to link the payment instrument to the member identifier.
